(19) United States
(12) Patent Application Publication
(10) Pub. No.: US 2021/0065509 A1
(43) Pub. Date: Mar. 4, 2021

(54) METHOD AND SYSTEM FOR PRESENTING A WAGERING GAME SIDE BONUS

(71) Applicant: My Box Gaming LLC, Las Vegas, NV (US)

(72) Inventor: Kenneth Perrie, Las Vegas, NV (US)

(21) Appl. No.: 15/929,521

(22) Filed: May 7, 2020

Related U.S. Application Data
(60) Provisional application No. 62/895,822, filed on Sep. 4, 2019.

(51) Int. Cl. G07F 17/32; A63F 1/02

(52) U.S. Cl. CPC G07F 17/3267; G07F 17/3211; G07F 17/3262; G07F 17/3293; A63F 2001/001; G07F 17/3258; A63F 1/02; G07F 17/3209; G07F 17/322

(57) ABSTRACT

A side bonus is provided for a base wagering game, wherein the winning side bonus can vary from game to game. In a method of presenting and playing the base wagering game, a player places a game wager and optional a side bonus bet. A target side bonus winning outcome is selected for the base wagering game from a set of a plurality of side bonus winning outcomes and that target side bonus winning outcome is displayed to the player. The base wagering game is then presented to the player and the base wagering game outcome is determined, along with the outcome of the side bonus. Sets of winning side bonus outcomes may be stored in a table along with associated payouts, and an RNG may be used to select a target winning side bonus outcome from the table for each instance of the base wagering game.

### RELATED APPLICATION DATA

The present application claims priority to U.S. Provisional Application Ser. No. 62/895,822, filed Sep. 4, 2019, which is incorporated herein by reference in its entirety.

### FIELD OF THE INVENTION

The present invention relates to gaming equipment and methods of presenting and playing games.

### BACKGROUND OF THE INVENTION

Game players are constantly seeking new and exciting games. Of course, a nearly infinite number of game variations can be created. A significant problem, however, is that most games are not viable for one or more reasons that are generally dependent upon the nature or type of the game and its players. For example, for a wagering game to be viable, it may need to satisfy a large number of criteria, including but not limited to: 1) being easy to learn; 2) being easy to play; 3) having a relatively high speed of play; 4) having odds of winning and payouts that entice the player to wager; and 5) having a sufficient “hold” to the house to make the game profitable to offer, among others. Unfortunately, very few games meet these criteria.

One way to overcome some of these issues is to try and start with an existing proven game and then attempt to modify the game to make it new and exciting. As one example, casinos often add a side bet to existing proven games. The side bet offers an additional wagering opportunity to the game, generally without changing the original game. For example, to make the game of blackjack more exciting, one implementation is three card side bet that the player's first two cards and the dealer's up card will form a designated combination of cards, such as a flush.

While such side bets can make the base game more exciting, the side bets themselves can also become stale. Relative to the example above, the blackjack game with three card side bet is static and plays the same way each time. After dozens or hundreds of hands, the game can become relatively dull to a player.

### SUMMARY OF THE INVENTION

Embodiments of the invention comprise a side bonus for a base game, such as a base wagering game. In one embodiment, the winning outcome for the side bonus may vary as to each instance of the base wagering game.

One embodiment of a method of presenting a game to a player at a gaming table comprises receiving a game wager and optionally a side bonus bet from the player, randomly selecting, via a controller of a computing device a target side bonus winning outcome from a set of a plurality of side bonus winning outcomes stored in a database associated with the controller, displaying the target side bonus winning outcome via a display associated with the gaming table, presenting a base wagering game to the player, determining an outcome of the base wagering game as to the player, awarding winnings to the player when the outcome of the base wagering game is winning, and when the player placed the optional side bonus bet, determining whether the player received the target side bonus winning outcome as a part of the play of the base wagering game, wherein when the player received the target side bonus winning outcome, awarding the player winnings.

The side bonus of the invention may be applied to various base games, including but not limited to wagering games such as poker games, Pai Gow, baccarat and blackjack.

In one embodiment, the plurality of side bonus winning outcomes may comprise one or more outcomes which do not comprise a winning outcome of the base wagering game. In a preferred embodiment, the outcome of the side bonus winning outcome is determined relative to the base game before game play decisions are made which affect play of the base game (such as a player discarding cards or hitting and taking additional cards), if any, so that the player's participation in the side bonus does not affect their strategy (or the dealer's) in playing the base game and attempting to obtain a winning base game outcome.

Winnings for a winning side bonus outcome may be defined by a pay table of target side bonus winning outcomes having associated awards. The winnings may comprise fixed amounts, progressive jackpots or awards of other types.

In one embodiment, the step of randomly selecting may comprise generating a random number and locating a target side bonus winning outcome corresponding to the generated random number from a table of the set of a plurality of side bonus winning outcomes. In one embodiment, the table is a weighted table of the set of side bonus winning outcomes.

Another embodiment of the invention comprises a game table configured to present a base wagering game and a side bonus, comprising a table having a game play surface configured to receive one or more game play pieces for playing the base wagering game, and defining a base wagering game betting location and a side bonus betting location, a wager detector configured to detect at least one of a base wagering game bet and a side bonus bet, at least one video display, a memory storing a table of a plurality of side bonus winning outcomes, and a controller configured to implement a random number generator to generate a random number, to locate a selected side bonus winning outcome from the table using the random number, and to cause the at least one video display to display the selected side bonus winning outcome corresponding to the base wagering game.

Yet another embodiment of the invention comprises a gaming machine comprising a housing, a controller, a memory, at least one electronic display, at least one player input device, at least one device configured to accept a physical element having associated funds for establishing a funds balance, and machine-readable code stored in the memory and executable by the controller to accept input from the player via the at least one player input device of a base game wager and a side bonus wager from the funds balance, to cause the controller to randomly select a target side bonus winning outcome from a set of a plurality of side bonus winning outcomes stored in the memory, to cause the controller to display the target side bonus winning outcome via the at least one electronic video display, to cause the controller to display base wagering game information via the at least one electronic video display, to cause the controller to determine an outcome of the base wagering game as to the player and award first winnings when the base outcome is winning, and to cause the controller to determine if the player received the target side bonus winning outcome as part of play of the base wagering game and award second winnings when the side bonus outcome is winning.

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a game table and associated game layout for playing and presenting a game of the invention;

FIG. 2 illustrates one embodiment of a gaming system in accordance with the invention;

FIG. 3 is a flow chart which illustrates one method of playing and/or presenting a game in accordance with the invention; and

FIG. 4 illustrates one embodiment of a gaming machine for presenting a game in accordance with the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods of playing and presenting games, and particularly a game having a variable side bonus, such as where a target winning outcome for the side bonus may change each time the underlying base game is played/presented.

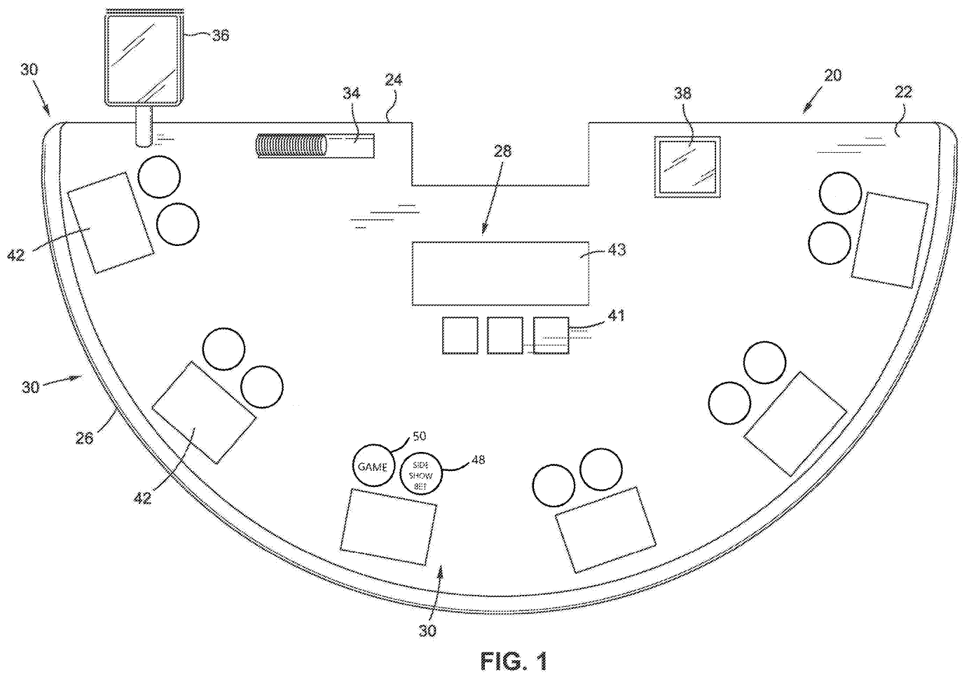

Additional aspects of the invention comprise equipment for presenting and playing the game, such as a uniquely configured gaming table. One embodiment of a gaming table in accordance with the invention will be described with reference to FIG. 1. As illustrated in FIG. 1, a game playing surface, such as a gaming table 20, is provided. The game table 20 defines a top or playing surface 22. The game table 20 may include one or more supports, such as a base, legs or the like (not shown) via which the playing surface 22 is elevated above a supporting surface such as a gaming floor.

The shape of the playing surface 22 may vary. In one embodiment, the game table 20 has a rear having a rear edge 24 which is generally straight and has an opposing front having a front edge 26 which is generally arcuate. A bumper or cushion may be located at either or both edges 24,26.

In one embodiment, the playing surface 22 is generally planar. However, the playing surface 22 could have one or more raised areas and/or one or more depressed areas or other features which are integrated into the table or added to the table, such as by being located on or mounted to the top surface thereof. Various game-related information or features are preferably associated with the game table 20. In one embodiment, the playing surface 22 comprises a gaming felt or similar element(s) which are located over a substrate, such as a planar support. The gaming felt may bear game play information or other information, such as by printing on the felt. This information may vary, such as depending upon the game or games which are to be implemented at the game table 20.

In one embodiment, the configuration of the game table 20, such as via elements which are associated with the table 20 and information printed on the gaming felt, defines a dealer station 28 where a dealer may run a game, and one or more player positions 30. The dealer station 28 is generally located at the rear edge 24 and the player positions 30 are located opposite the dealer station 28 at the front or front edge 26. The dealer may, for example, stand at the rear of the table adjacent to the dealer station 28. A player may stand or sit adjacent to each player position 30 at the front of the game table 20.

For example, printing on the gaming felt may comprise one or more pay tables, player card locations 42 (e.g. one or more designated areas at or into which one or more cards may be dealt), a dealer card location 43, and if the game includes community cards, one or more community card locations 41. Printing on the felt, one or more displays or plaques or the like may display game rules, pay tables and other game information.

In one embodiment, the game which is presented at the game table 20 comprises a wagering game. Wagers may be placed using physical gaming chips or other elements. In one embodiment, the game table 20 may define one or more wagering areas. As described in more detail below, the game may require a player to place one or more game wagers and thus one or more game wager locations 50 may be provided. The number of game wager locations may vary depending upon the particular game being played. For example, the game might only require a single game wager, or might require an ante and a play wager, or an ante and then two or more raise wagers, etc. In addition, a player may place one or more optional side wagers or side bets. In one embodiment, such a side bet or side wager may be referred to as a Side Show Bonus bet, wherein the player may place the optional Side Show Bonus bet, such as via a Side Show Bonus bet location 48. These areas or locations 48,50 may be defined on the game table 20 (such as by printing on a felt surface thereof and/or via raised or depressed areas or other physical features), such as in conjunction with each player position 30.

In one embodiment, a player may place one or more chips at the wagering locations 48,50 in order to play the game and participate in the Side Show Bonus and the dealer may manually view the chips to confirm placement of the bets. In another embodiment, wagers by players may be sensed by detecting the association of one or gaming chips (or monies or other wagering implements) with one or more input receiving devices or input sensors 32. The input receiving devices or input sensors 32 might comprise buttons (wired or wireless), or other input devices, including RFID chip readers, proximity sensors and other types of sensors. The input receiving devices 32 may be located in or on the game table 20 and are configured to detect inputs, such as provided by players at the playing surface 22. In the case of proximity sensors, the sensors may be any type of proximity sensor now known or later developed, such as IR, acoustic, capacitive, or the like

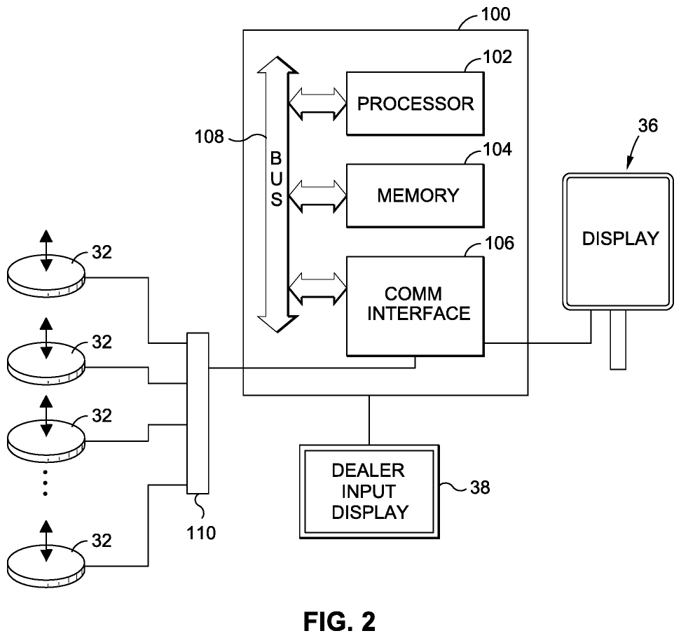

In one embodiment, as illustrated in FIG. 2, one or more input receiving devices 32 are associated with each player position 30, thereby providing a means for each player to provide input relative to game play at the gaming table (and whereby the wagers of each player may be distinguished from those of the other players). For example, a different input receiving device 32 might be associated with each different wagering area, whereby wagers placed by a player relative to one or more different wagering areas may be independently detected.

In one embodiment, the dealer station 28 may include one or more chip trays 34 which are located on or at the game table 20 for storing chips which may be used to pay player winnings and/or in which chips which were used by players to place wagers may be collected.

In one embodiment, the game table 20 may include a number of other features. For example, the game table 20 may include one or more table displays 36. The table display 36 may comprise an electronic video display (such as an LCD, LED, OLED, DLP or other types of displays which are now known or later developed). The table display 36 may be located at or near the game table 20 for use in displaying game related information. The table display 36 might also be used to display promotional information or advertising. In one embodiment, the table display 36 displays the Side Show Bonus winning outcome for a game and the payout for that Side Show Bonus.

The game table 20 might also comprise or include various input devices and/or other display devices. The input devices might include one or more dealer input devices such as one or more buttons or a dealer touchscreen display 38. For example, the dealer display 38 might comprise a display which displays game-related information to the dealer and allows the dealer to provide various inputs, including an input to cause the selection or display of a target winning Side Show Bonus outcome for a game.

Of course, various other types of input and display devices might be associated with the game table 20. The game table 20 might also include player touch-screens, input buttons or the like. For example, in a case where electronic game credits are tracked, a player might place a game wager and side bet via a touch screen.

Still referring to FIG. 2, additional details of a gaming table in accordance with one embodiment of the invention will be described. As illustrated, in this embodiment, elements of the game table 20 are associated with or connected to at least one table controller 100. The table controller 100 may be located at the game table 20 or may be remote therefrom.

In one embodiment, the table controller 100 comprises at least one processor 102 which is configured to execute machine readable code fixed in a tangible medium (e.g. “software”). The table controller 100 may also comprise one or more information or data storage devices 104. These data storage devices 104 may comprise any type of data storage device such as ROM, RAM, EPROM or the like, as well as mass storage devices such as hard drives. The data storage devices 104 may store various data, including game code or software which is executable by the processor(s) 102 and other data, such as game data including wager data, game outcome data, images, etc.

The table controller 100 preferably includes one or more communication interfaces 106. The communication interface(s) 106 may facilitate wireless and/or wired communications with one or more remote systems or devices in accordance with various protocols (USB, Wi-Fi, Bluetooth, Ethernet, Firewire, etc.). In one embodiment, data or information may be exchanged between the processor(s) 102, data storage device(s) 104 and communication interface(s) 106 via one or more interfaces, such as a system bus 108. Of course, the table controller 100 might have other configurations, including other elements or features.

As illustrated in FIG. 2, the one or more input receiving devices 32 of the gaming table 20 may be interfaced with the table controller 100 to that the table controller 100 may receive information from those devices 32 and, in some embodiments, to transmit information to those devices. Likewise, the dealer input and/or display devices, such as the dealer touchscreen 38, may be interfaced to the table controller 100. Also, other input and/or display devices such as the table display 36 may be interfaced to the table controller 100.

In one embodiment, the table controller 100 or other devices associated with the game table 20 may determine player monetary or chip value balances, including based upon monies associated with the table by the player (such as chips purchased), amounts wagered and amounts won or the like.

The game table 20 of the invention may include or be associated with other elements or devices. For example, the game table 20 might include other gaming equipment, such as one or more player displays (such as located at each player position and configured to display game information, player tracking information, advertising or other information), card shoe(s), card reader(s), card shuffler(s), player tracking devices (such as for reading a player tracking card or other media of a player for use in tracking the player's game play) and the like. The game table 20 might also be connected to external devices. For example, the table controller 100 might be connected to one or more casino servers or systems, such as a casino accounting server which tracks game play at each game table 20, such as relative to the amounts of wagers placed and winnings paid to the players, among other information. The game table 20 might also be connected to a player tracking server and include player tracking elements such as player card readers.

The gaming system might include other elements, such as input receiving device controllers or the like. In one embodiment, the input receiving devices 32 communicate with a hub or aggregator 110 which communicates with the table controller 100. The hub 110 may be configured to read or determine the status of each input receiving device 32 and provide information to the table controller 100, such as when the status of an input receiving device 32 changes. The hub 110 may also comprise a power source for the input receiving devices 100. As another example, a proximity-type input sensor might be configured as a USB type device having a USB controller. The table controller 100 may be configured to control the proximity device as a USB device. In this regard, the processor 102 and/or one or more sub-processors or controllers may be utilized to control the input receiving devices.

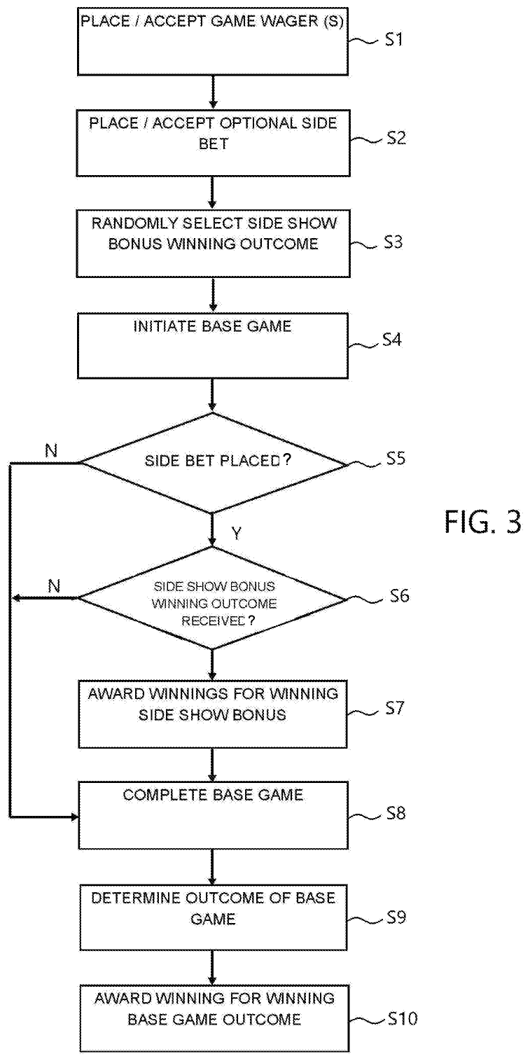

Additional details of methods, devices and systems of the invention will now be described. FIG. 3 is a flow diagram which illustrates one method of presenting and playing a game in accordance with one embodiment of the invention, wherein the method includes the presentation of a Side Show Bonus. As detailed herein, the game might be played or presented at a gaming machine or device, at a gaming table or the like. In a preferred embodiment, the game is played at a gaming table by a dealer and at least one player, such as up to 6 or 7 players or more.

One embodiment of the invention is a side bonus for a base game. The base game may be a wagering game. As described below, such a base wagering game might comprise any of various games now known or later developed, including but not limited to blackjack, poker (including the many variations thereof), Pai Gow, baccarat and other games.

When such a base game is a wagering game, the player may be required to place at least one wager in order to play the game and provide the player with the opportunity to be awarded winnings. Thus, in one embodiment, in a step S1, a player places at least one game wager.

In accordance with the invention, the player is permitted to place (but is not required to place) an optional side bet, as at step S2. In one embodiment, the optional side bet is a Side Show Bonus, as described in more detail below.

In one embodiment, a player places one or more chips, coins or the like at the wager location corresponding to the wager(s) they would like to place (such as the game wager location 50 and Side Show Bonus bet location 48), such as by locating the one or more chips or the like in proximity to the one or more sensors for detection thereby. Each wager may be required to be of a certain minimum size and may also have a maximum size.

In a step S3, a Side Show Bonus winning outcome is selected. In one embodiment, as described in further detail below, a set comprising a plurality, e.g. two or more, of Side Show Bonus winning outcomes are defined. One of those outcomes is selected, preferably randomly. This selected outcome comprises the defined or target Side Show Bonus winning outcome for the instance of the game. In a preferred embodiment, information regarding the selected or target Side Show Bonus winning outcome is provided to the players. For example, the target Side Show Bonus winning outcome may be displayed on player displays or a table display.

In step S4, the base game is presented, or at least initiated. This may comprise the dealer dealing or causing cards to be dealt, such as from one or more decks of physical playing cards. The one or more decks of cards may comprise 52 card decks where the cards have a front and a back, wherein the front or face thereof (but not the back) displays card rank and suit indicia comprising the suits Hearts, Diamonds, Spades and Clubs, with the ranks (from lowest to highest) 2-10, Jack, Queen, and King, and where an Ace. The one or more decks might also include one or more Jokers, or might comprise modified decks of cards or special decks of cards. Where multiple players are playing the game, a different player hand may be dealt to each player, such as to the player location corresponding to each player (but only a single dealer hand is dealt). The dealer hand may be dealt to the dealer hand area 43 of the dealer position 28 and the player hands may be dealt to the player hand areas 42 of the player positions 30.

Of course, the game pieces that are used in the base game, the manner of distributing the of game pieces, the number of game pieces, etc., may all vary depending upon the particular base game. As indicated above, the base game might also require a player to place one or more additional game wagers in order to remain in the base game until completion.

In a preferred embodiment, the outcome of the Side Show Bonus is determined before a player (or dealer, relative to use of game piece of the dealer) makes any decisions relative to the play of the base wagering game that may change the outcome of the base game. As disclosed below, this preferred configuration ensures that the player (or dealer) is not forced to alter their base game play strategy because of the Side Show Bonus (which may, among other things, then affect the outcomes of the base game and thus the house hold, etc. for the base game, thus impacting the base game). For example, the Side Show Bonus is preferably determined after the initial hands are dealt in the game of blackjack if the Side Show Bonus is evaluated relative to the player's cards (e.g. before the player “hits” by taking any additional cards). Or in the case of draw poker, the outcome of the Side Show Bonus is preferably determined before the player discards and obtains replacement cards. In games like stud poker where the cards which are dealt to the player and/or dealer are static, or in games where determinations of whether additional cards are dealt are determined by rule and not player decision, the base game may be completed before evaluating the outcome of the Side Show Bonus. As another example, if the outcome of the Side Show Bonus is determined relative to only the cards of the dealer in a game of blackjack, the outcome of the Side Show Bonus might be determined at the end of the blackjack game because any cards that the dealer obtains during the play of the blackjack game (beyond the initial two dealer cards) are determined by rule and not variable by the player or dealer, whereby play of the base game relative to the dealer's cards can't be varied in consideration of the Side Show Bonus.

Thus, in a step S5, it is determined whether the player placed a Side Show Bonus bet. If in step S5 it is determined that the player placed the Side Show Bonus bet, then in step S6, it is determined whether the player received a Side Show Bonus winning outcome as part of play of the base game. If the player won the Side Show Bonus, then in step S7, the player may be awarded winnings. The amount of the winnings may, as detailed below, be based upon a pay table or in other manners. In a preferred embodiment, the player can thus win the Side Show Bonus regardless of whether the outcome of the base game was winning or losing. Of course, if the player placed a Side Show Bonus bet and lost that bet, then the dealer/house preferably collects the player's Side Show Bonus bet.

After the determinations in steps S5 and S6 and payment of any winnings for a winning Side Show Bonus in step S7, if the base game was not completed, then in step S8 the base game is then completed (such as by allowing the player to elect to discard cards and obtain replacement cards, to hit and take additional cards, etc.,—as per the rules of the base game).

In step S9, the outcome of the base game may be determined. This step depends upon the base game, and namely the criteria for winning the base game. For example, where the base game comprise a card game, this step may comprise comparing a hand of the player to a pay table of winning outcomes, comparing the player's hand to the dealer's hand, and/or comparing the player's hand to the hands of one or more other players. In general, the step comprises determining whether the outcome of the base game was a winning or losing outcome to the player.

In a step S10, if the outcome of the base game is winning as to the player, the player may be awarded winnings. The winnings might comprise a set amount of winnings based upon a pay table, might comprise a pot, or more might comprise a variable award such as a jackpot. The winnings might be awarded in various forms, including as chips, electronic credits, etc., as further detailed below.

It will be appreciated that the above-described steps and their order are exemplary, but not limiting. For example, the steps would not need to be performed in the exact order described. As one example, the target Side Show Bonus could be selected and displayed before wagers are accepted.

In one embodiment, the side bonus feature might be presented without requiring that the player place a separate side bet from the base game wager. For example, the Side Show Bonus of the present invention might be presented as part of a base wagering game based upon the base game wager (whereby a separate Side Show Bonus bet may be optional in the sense that it is not required at all). In such a configuration, every player who placed a base game wager would participate in the side bonus feature. If the house hold for the base game is sufficiently high, awards for winning side bonus outcomes might be paid from the house hold associated with the base game. If the house hold for the base game is not high enough for this configuration, then the base game might be altered in order to raise the house hold on the base game (such as by reducing awards for winning base game payouts, changing the outcomes that are winning outcomes for the base game to a smaller set, etc.).

Additional aspects of the invention will now be described.

As indicated, an embodiment of the invention comprise a side bonus for a base game. Preferably, the side bonus for the base game—e.g. the one or more winning outcomes for the side bonus, change at one or more times. Preferably, the side bonus winning outcome may change from game to game. In one embodiment, the target or winning side bonus outcome for each base game is randomly selected from a plurality of possible winning outcomes. Such side bonus winning outcomes preferably comprise different events or outcomes that may be received as a result of the play of the base game. In one embodiment, the side bonus winning outcomes may comprise outcomes that are different from the winning outcomes for the base game. One aspect of the invention thus comprises the step or feature of defining a plurality of possible events that may occur during or as a result of the play of the base game (or at least the portion of the game which meets the preferred criteria described above) and selecting a plurality of those events to comprise a set of side bonus winning outcomes from which individual outcomes are selected for each game.

As indicated above, in a preferred embodiment, the Side Show Bonus is evaluated relative to presentation of the base game based upon an initial set of game pieces or elements in the base game, but before the player (or other dealer or other participant) makes any subsequent elective game play decisions that could be used to alter the base game play relative to the Side Show Bonus, when such options exist in the game or exist relative to the game pieces being used to determine the outcome of the Side Show Bonus. As one example, in the game of blackjack an initial two card player hand and an initial two card dealer hand are dealt, wherein only one of the dealer's cards is dealt face-up. Thereafter, either the player or dealer may “hit” and take one or more additional cards, whereby the total number of cards used in the blackjack game might comprise 5, 6 or more cards. In accordance with the invention, the Side Show Bonus winning outcomes might thus preferably comprise one or more combinations of cards that can be obtained from the three cards comprising the initial 2 cards dealt to the player and the dealer's up-card, and not combinations of cards that might be made from the 5 or 6 cards that might ultimately be used in the game.

Table 1 below illustrates one example of a table of side bonus winning outcomes and associated payouts for those outcomes, associated with a base blackjack game, and namely the initial two cards dealt to the player and/or dealer. In one embodiment, one of these outcomes is randomly selected for each hand or game of blackjack that is presented. As one example, the outcome “player total of 10” may be selected at the start of a particular hand of blackjack. If the player's initial two cards have a point total of 10, then the player wins the Side Show Bonus for that hand of blackjack. In this table, the Probability represents the probability of the event occurring in the base game, the Payout represents a multiplier of the Side Show Bonus (for example, a payout of 61 would comprise $61 for a 1$ Side Show Bonus), the Payout % comprises the average percentage payout for that outcome, and the H.A. represents the house advantage for the bet.

TABLE 1

| Blackjack Game Event | | | | |
|---|---|---|---|---|
| (from Player's Initial | | | | |
| Two Card Hand and/or | Proba- | | Payout | |
| Dealer's Upcard | bility | Payout | % | H.A. |
| Player total of 3 | 0.0118 | 61 | 0.7198 | 0.2802 |
| Player total of 4 | 0.01775 | 51 | 0.90525 | 0.0948 |
| Player total of 5 | 0.0237 | 36 | 0.8532 | 0.1468 |
| Player total of 6 | 0.0296 | 31 | 0.9176 | 0.0824 |
| Player total of 7 | 0.0355 | 26 | 0.923 | 0.077 |
| Player total of 8 | 0.0414 | 21 | 0.8694 | 0.1306 |
| Player total of 9 | 0.0473 | 19 | 0.8987 | 0.1013 |
| Player total of 10 | 0.0532 | 16 | 0.8512 | 0.1488 |
| Player total of 11 | 0.0947 | 9 | 0.8523 | 0.1477 |
| Player total of 12 | 0.101 | 9 | 0.909 | 0.091 |
| Player total of 13 | 0.0947 | 9 | 0.8523 | 0.1477 |
| Player total of 14 | 0.0888 | 11 | 0.9768 | 0.0232 |
| Player total of 15 | 0.0828 | 11 | 0.9108 | 0.0892 |
| Player total of 16 | 0.077 | 11 | 0.847 | 0.153 |
| Player total of 17 | 0.071 | 12 | 0.852 | 0.148 |
| Player total of 18 | 0.065 | 14 | 0.91 | 0.09 |
| Player total of 19 | 0.059 | 16 | 0.944 | 0.056 |
| Player total of 20 | 0.1065 | 9 | 0.9585 | 0.0415 |
| Player Blackjack | 0.0473 | 21 | 0.9933 | 0.0067 |
| Player Suited Blackjack | 0.0118 | 76 | 0.8968 | 0.1032 |
| Player Specific Card (7C) | 0.0381 | 21 | 0.8001 | 0.1999 |
| Each | | | | |
| Player Non-Spec. Card (A) | 0.148 | 6 | 0.888 | 0.112 |
| Each | | | | |
| Player Non-Spec. Card (K) | 0.148 | 6 | 0.888 | 0.112 |
| Each | | | | |
| Player Non-Spec. Card (Q) | 0.148 | 6 | 0.888 | 0.112 |
| Each | | | | |
| Player Non-Spec. Card (J) | 0.148 | 6 | 0.888 | 0.112 |
| Each | | | | |
| Player Non-Spec. Card (10) | 0.148 | 6 | 0.888 | 0.112 |
| Each | | | | |
| Player Non-Spec. Card (9) | 0.148 | 6 | 0.888 | 0.112 |
| Each | | | | |
| Player Non-Spec. Card (8) | 0.148 | 6 | 0.888 | 0.112 |
| Each | | | | |
| Player Non-Spec. Card (7) | 0.148 | 6 | 0.888 | 0.112 |
| Each | | | | |
| Player Non-Spec. Card (6) | 0.148 | 6 | 0.888 | 0.112 |
| Each | | | | |
| Player Non-Spec. Card (5) | 0.148 | 6 | 0.888 | 0.112 |
| Each | | | | |
| Player Non-Spec. Card (4) | 0.148 | 6 | 0.888 | 0.112 |
| Each | | | | |
| Player Non-Spec. Card (3) | 0.148 | 6 | 0.888 | 0.112 |
| Each | | | | |
| Player Non-Spec. Card (2) | 0.148 | 6 | 0.888 | 0.112 |
| Each | | | | |
| Player Suited Pair | 0.0169 | 51 | 0.8619 | 0.1381 |
| Player Any Pair | 0.0747 | 12 | 0.8964 | 0.1036 |
| Player Specific Pair | 0.0057 | 151 | 0.8607 | 0.1393 |
| Player Two Black Cards | 0.249 | 4 | 0.996 | 0.004 |
| Player Two Red Cards | 0.249 | 4 | 0.996 | 0.004 |
| Player Two Suited Cards | 0.248 | 4 | 0.992 | 0.008 |
| Player Two Specific Suited | 0.062 | 15 | 0.93 | 0.07 |
| Cards | | | | |
| Player One Face Card | 0.356 | 3 | 1.068 | −0.068 |
| Player Two Face Cards | 0.053 | 16 | 0.848 | 0.152 |
| Player and Dealer Any Flush | 0.0496 | 19 | 0.9424 | 0.0576 |
| Player and Dealer Specific | 0.0124 | 76 | 0.9424 | 0.0576 |
| Flush | | | | |
| Player and Dealer Any Straight | 0.0326 | 26 | 0.8476 | 0.1524 |
| Player and Dealer Three of | 0.00235 | 251 | 0.58985 | 0.4102 |
| a Kind | | | | |
| Player and Dealer 3 Black | 0.1176 | 8 | 0.9408 | 0.0592 |
| Cards | | | | |
| Player and Dealer 3 Red | 0.1176 | 8 | 0.9408 | 0.0592 |
| Cards | | | | |
| Player and Dealer 2 Black | 0.5 | 2 | 1 | 0 |
| Cards | | | | |
| Player and Dealer 2 Red | 0.5 | 2 | 1 | 0 |
| Cards | | | | |
| Player and Dealer Specific | 0.0577 | 16 | 0.9232 | 0.0768 |
| Card (7C) Each | | | | |
| Player and Dealer Non-Spec. | 0.217 | 4 | 0.868 | 0.132 |
| Card (A) Each | | | | |
| Player and Dealer Non-Spec. | 0.217 | 4 | 0.868 | 0.132 |
| Card (K) Each | | | | |
| Player and Dealer Non-Spec. | 0.217 | 4 | 0.868 | 0.132 |
| Card (Q) Each | | | | |
| Player and Dealer Non-Spec. | 0.217 | 4 | 0.868 | 0.132 |
| Card (J) Each | | | | |
| Player and Dealer Non-Spec. | 0.217 | 4 | 0.868 | 0.132 |
| Card (10) Each | | | | |
| Player and Dealer Non-Spec. | 0.217 | 4 | 0.868 | 0.132 |
| Card (9) Each | | | | |
| Player and Dealer Non-Spec. | 0.217 | 4 | 0.868 | 0.132 |
| Card (8) Each | | | | |
| Player and Dealer Non-Spec. | 0.217 | 4 | 0.868 | 0.132 |
| Card (7) Each | | | | |
| Player and Dealer Non-Spec. | 0.217 | 4 | 0.868 | 0.132 |
| Card (6) Each | | | | |
| Player and Dealer Non-Spec. | 0.217 | 4 | 0.868 | 0.132 |
| Card (5) Each | | | | |
| Player and Dealer Non-Spec. | 0.217 | 4 | 0.868 | 0.132 |
| Card (4) Each | | | | |
| Player and Dealer Non-Spec. | 0.217 | 4 | 0.868 | 0.132 |
| Card (3) Each | | | | |
| Player and Dealer Non-Spec. | 0.217 | 4 | 0.868 | 0.132 |
| Card (2) Each | | | | |
| Player and Dealer Any Pair | 0.167 | 6 | 1.002 | −0.002 |
| Player and Dealer Specific Pair | 0.0132 | 61 | 0.8052 | 0.1948 |
| Player and Dealer Two Spades | 0.15 | 6 | 0.9 | 0.1 |
| Player and Dealer Two Clubs | 0.15 | 6 | 0.9 | 0.1 |
| Player and Dealer Two Hearts | 0.15 | 6 | 0.9 | 0.1 |
| Player and Dealer Two | 0.15 | 6 | 0.9 | 0.1 |
| Diamonds | | | | |
| Player and Dealer One Spade | 0.586 | 2 | 1.172 | −0.172 |
| Player and Dealer One Club | 0.586 | 2 | 1.172 | −0.172 |
| Player and Dealer One Heart | 0.586 | 2 | 1.172 | −0.172 |
| Player and Dealer One Diamond | 0.586 | 2 | 1.172 | −0.172 |
| Player and Dealer One | 0.553 | 2 | 1.106 | −0.106 |
| Face Card | | | | |
| Player and Dealer Two | 0.13 | 6 | 0.78 | 0.22 |
| Face Cards | | | | |
| Player and Dealer Total of | 0.0863 | 11 | 0.9493 | 0.0507 |
| 21 | | | | |
| Player and Dealer Total of | 0.0753 | 12 | 0.9036 | 0.0964 |
| 20 | | | | |
| Player and Dealer Total of | 0.0727 | 12 | 0.8724 | 0.1276 |
| 19 | | | | |
| | 15.86% | | | 9.06% |

Table 2 below illustrates one example of a table of side bonus winning outcomes and associated payouts for those outcomes, associated with a base three card poker game. In one embodiment, one of these outcomes is randomly selected for each hand or game of poker that is presented.

TABLE 2

| Three Card Poker | | | | |
|---|---|---|---|---|
| Event (Player and/or | Proba- | | Payout | |
| Dealer cards) | bility | Payout | % | H.A. |
| Three Red Cards | 0.1176 | 8 | 0.9408 | 0.0592 |
| Three Black Cards | 0.1176 | 8 | 0.9408 | 0.0592 |
| Two Red Cards (or more) | 0.5 | 2 | 1 | 0 |
| Two Black Cards (or more) | 0.5 | 2 | 1 | 0 |
| One Specific Card (5 Club) | 0.0577 | 16 | 0.9232 | 0.0768 |
| One Card (5 any suit) | 0.217 | 4 | 0.868 | 0.132 |
| Particular Pair (5's) | 0.0132 | 51 | 0.6732 | 0.3268 |
| Any Pair | 0.167 | 6 | 1.002 | −0.002 |
| Any Flush | 0.0496 | 21 | 1.0416 | −0.0416 |
| Any Straight | 0.0326 | 26 | 0.8476 | 0.1524 |
| Any 3 of a Kind | 0.00235 | 251 | 0.58985 | 0.4102 |
| Two of a Particular Suit | 0.15 | 6 | 0.9 | 0.1 |
| (Hearts) | | | | |
| Two of a Particular Suit | 0.15 | 6 | 0.9 | 0.1 |
| (Clubs) | | | | |
| Two of a Particular Suit | 0.15 | 6 | 0.9 | 0.1 |
| (Diamonds) | | | | |
| Two of a Particular Suit | 0.15 | 6 | 0.9 | 0.1 |
| (Spades) | | | | |
| One of a Particular Suit | 0.586 | 2 | 1.172 | −0.172 |
| (or more) | | | | |
| No Face Cards | 0.447 | 2 | 0.894 | 0.106 |
| One Face Card (or more) | 0.553 | 2 | 1.106 | −0.106 |
| Two Face Cards (or more) | 0.13 | 7 | 0.91 | 0.09 |
| Three Face Cards | 0.01 | 101 | 1.01 | −0.01 |
| Dealer Not Qualify | 0.304 | 3 | 0.912 | 0.088 |
| | 20.90% | | 0 | 7.47% |

Table 3 below illustrates one example of a table of side bonus winning outcomes and associated payouts for those outcomes, associated with a base Pai Gow poker game. In one embodiment, one of these outcomes is randomly selected for each hand or game of poker that is presented.

TABLE 3

| Pai Gow Poker Event | | | | |
|---|---|---|---|---|
| (Player and/or | Proba- | | Payout | |
| Dealer cards) | bility | Payout | % | H.A. |
| One Particular Card (Joker) | 0.132 | 7 | 0.924 | 0.076 |
| Any Ace (including Joker) | 0.522 | 2 | 1.044 | −0.044 |
| Any 9 (at least 1) | 0.443 | 2 | 0.886 | 0.114 |
| One Pair Only | 0.42 | 2 | 0.84 | 0.16 |
| One Particular Pair (7's) | 0.08 | 12 | 0.96 | 0.04 |
| Pair of Aces (Joker Eligible) | 0.124 | 8 | 0.992 | 0.008 |
| Two Pair Only | 0.23 | 4 | 0.92 | 0.08 |
| 3 of a Kind Only | 0.0485 | 21 | 1.0185 | −0.0185 |
| Straight | 0.073 | 13 | 0.949 | 0.051 |
| Flush | 0.04 | 21 | 0.84 | 0.16 |
| Full House | 0.0271 | 31 | 0.8401 | 0.1599 |
| Lop Lop | 0.153 | 6 | 0.918 | 0.082 |
| Two or More Hearts (No Joker) | 0.555 | 2 | 1.11 | −0.11 |
| Two or More Hearts (Joker) | 0.6 | 2 | 1.2 | −0.2 |
| Three or More Clubs (No Joker) | 0.2224 | 4 | 0.8896 | 0.1104 |
| Three or More Clubs (Joker) | 0.264 | 3 | 0.792 | 0.208 |
| Four or More Spades (No Joker) | 0.053 | 16 | 0.848 | 0.152 |
| Four or More Spades (Joker) | 0.07 | 13 | 0.91 | 0.09 |
| 4 or More Red Cards (No Joker) | 0.478 | 2 | 0.956 | 0.044 |
| 5 or More Black Cards (No Joker) | 0.1944 | 5 | 0.972 | 0.028 |
| 6 or More Red Cards (No Joker) | 0.0446 | 21 | 0.9366 | 0.0634 |
| 7 Red or Black Cards (No Joker) | 0.0085 | 101 | 0.8585 | 0.1415 |
| | 21.70% | | 0 | 6.34% |

Table 4 below illustrates one example of a table of side bonus winning outcomes and associated payouts for those outcomes, associated with a base seven card stud poker game. In one embodiment, one of these outcomes is randomly selected for each hand or game of poker that is presented.

TABLE 4

| Lucky Colors Event (Relative to | Proba- | | Payout | |
|---|---|---|---|---|
| Player's 7 Card Hand) | bility | Payout | % | H.A. |
| 4 or more Red Cards (with J) | 0.522 | 2 | 1.044 | −0.044 |
| 4 or more Black Cards (with J) | 0.522 | 2 | 1.044 | −0.044 |
| Specific Card (2 of Clubs) | 0.132 | 7 | 0.924 | 0.076 |
| Specific Card (4 of Spades) | 0.132 | 7 | 0.924 | 0.076 |
| Specific Card (Joker) | 0.132 | 7 | 0.924 | 0.076 |
| At Least One Black 9 | 0.2489 | 4 | 0.9956 | 0.0044 |
| At least One Red 5 | 0.2489 | 4 | 0.9956 | 0.0044 |
| At least One 7 | 0.4427 | 2 | 0.8854 | 0.1146 |
| Specific Pair (Red 8 s) | 0.01524 | 51 | 0.77724 | 0.2228 |
| Specific Pair (Black 6s) | 0.01524 | 51 | 0.77724 | 0.2228 |
| At least One Black Pair | 0.198 | 5 | 0.99 | 0.01 |
| At least One Red Pair | 0.198 | 5 | 0.99 | 0.01 |
| No Face Cards | 0.146 | 6 | 0.876 | 0.124 |
| At least One Black Face Card | 0.59 | 2 | 1.18 | −0.18 |
| At least One Red Face Card | 0.59 | 2 | 1.18 | −0.18 |
| At Least Two Black Face Cards | 0.174 | 6 | 1.044 | −0.044 |
| At Least Two Red Face Cards | 0.174 | 6 | 1.044 | −0.044 |
| At Least Three Black Face Cards | 0.0248 | 31 | 0.7688 | 0.2312 |
| At Least Three Red Face Cards | 0.0248 | 31 | 0.7688 | 0.2312 |
| 5 or more Red Cards (with J) | 0.226 | 4 | 0.904 | 0.096 |
| 5 or more Black Cards (with J) | 0.226 | 4 | 0.904 | 0.096 |
| Either Color (5 or more with J) | 0.452 | 2 | 0.904 | 0.096 |
| Either Color (6 or more with J) | 0.1114 | 8 | 0.8912 | 0.1088 |
| 6 or more Red Cards (with J) | 0.0557 | 16 | 0.8912 | 0.1088 |
| 6 or more Black Cards (with J) | 0.0557 | 16 | 0.8912 | 0.1088 |
| Either Color (7 or more with J) | 0.0115 | 101 | 1.1615 | −0.1615 |
| | 0.218 | | 0 | 0.051 |

In one embodiment, Side Show Bonus winning outcomes may be selected using a random number generator (RNG). For example, Table 4 shows an example where 26 different winning outcomes are defined. An RNG may be implemented via software (an example of which is detailed below) and may be configured to randomly select numbers between 1 and 26, wherein the particular outcome associated with a randomly select number is used as the target winning Side Show Bonus. As one example, the table of winning outcomes and RNG may be stored in a memory. A controller, such as the table controller (such as processor 102 as illustrated in FIG. 2) or a processor of a remote game server may run the RNG and use the output of the RNG to lookup corresponding Side Show Bonus winning outcomes from the stored table (such as stored in the memory 104 illustrated in FIG. 2). At the start of each game, the dealer might press a “select Side Show Bonus outcome” and that input may cause the controller or server to select one of the outcomes. Once a target outcome is selected, it may be displayed on the table display or the like. As indicated, however, a dealer input may create a “call” to a remote server or other devices which transmits back a selected target winning outcome and causes such to be displayed or revealed at the table.

In one embodiment, Side Show Bonus winning outcomes may be defined by a weighted table. For example, relative to Table 4, the outcome “At least one Black Face Card” might be weighted 100 times higher than the outcome “Either Color”, such as by defining a table in which “At least one Black Face Card” occurs 100 times and “Either Color” occurs 1 time. The total size of the table may then be defined by all of the possible winning outcomes (in the number of each outcome) and an RNG may then be used to select numbers from the possible winning outcome. In the example just noted, the first 100 positions might be associated with “At Least One Black Face Card” and position 101 might be associated with “Either Color”. If the RNG selected any number between 1-100, it would result in the selection of “At Least One Black Face Card” and only if the RNG selected the number 101 would it result in the selection of “Either Color.” In such a configuration, it can be seen that the random selection of outcomes still results in the potential for any possible winning outcome to be selected, but where the odds of the selection of different winning outcomes may be different.

In one embodiment, awards for winning Side Show Bonus outcomes may be defined by a pay table. However, winnings might be awarded in manners other than via a pay table. For example, a player may be awarded side bonus winnings based upon an award selection event such as a spin of an award wheel. For example, referring to FIG. 1, in one embodiment an award wheel may be displayed graphically on the display 36 at the game table 20. Each player who received a winning Side Show Bonus is given the opportunity to spin the wheel. As indicated above, in one embodiment, an input receiving device 32 may be activated. The player may then wave their hand or provide input to the input receiving device 32. The table controller 100 may then cause the display 36 to display a graphical representation of a spinning wheel which stops at a selected segment which corresponds to define the outcome of the wheel spin, and thus indicate the award which is awarded to the player. In such a configuration, the wheel spaces may display various awards, where those awards might vary depending upon the particular winning side bonus outcome which the player received.

In one embodiment, the virtual wheel may be configured with segments which have associated awards and the probability of a particular segment being selected may be weighted. In the wheel spin event, a random number generator or the like may be used to generate a random number which is then compared to a lookup table of outcomes. The selected outcome corresponds to a segment having an assigned award. The controller may then cause the display 36 to display a wheel spin in which the wheel stops at the selected segment. In this configuration, certain outcomes or awards are more likely to occur than others

Of course, the wheel spin event could be implemented by spinning a physical spinning wheel, such as where the stopping position of the wheel relative to a pointer or other selector is controlled, such as via a motor. The award selection event might also be represented by other than a wheel spin, but by other events.

Awards for winning Side Show Bonus outcomes might be fixed values, but might be variable. For example, one or more progressive jackpots—e.g. jackpots that change value over time, such as based upon amounts wagered, number of games played and the like, may be utilized. Different jackpots could be provided for different target winning Side Show Bonus outcomes or a single jackpot might be provided, wherein a player might win all or a portion of the progressive jackpot). In one embodiment, once a player wins the jackpot, it might reset to a base seed value and then grow.

Winnings (for winning game wagers or side bonus wagers) might be paid in the form of chips, electronic credits or the like. The player might cash-out electronic credits to a printed ticket or the like, such as printed and issued by a printer at a gaming table or device. The player might then take that ticket to a cashier station or window for redemption, such as conversion to monetary funds. Likewise, a player might cash out chips in a similar manner.

In one embodiment, a player can win the Side Show Bonus regardless of the outcome of the base game. In a preferred embodiment, the outcome of the Side Show Bonus is determined before decisions in the base game that may alter the play strategy in the base game. However, in other embodiments, the side bonus could be determined at other times, such as after the presentation of the base game including certain player decisions such as discarding cards or hitting and taking additional cards.

As indicated, the game of the invention may be implemented in various manners, such as via various gaming machines, devices and/or systems. For example, the methods of game play and presentation may also be implemented via an electronic gaming machine or device. Such a gaming machine may have various configurations.

The gaming machine may be located at a casino (and as such may be referred to as a “casino gaming machine”). As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

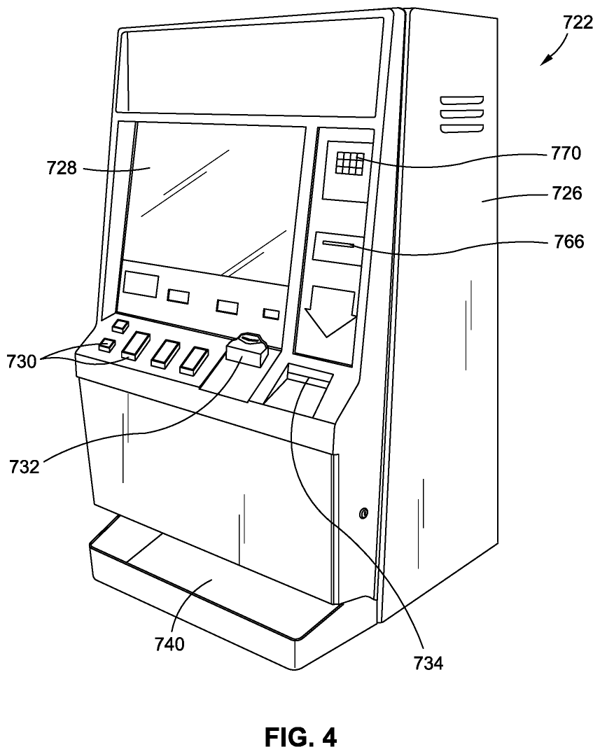

One configuration of a gaming machine 722 is illustrated in FIG. 4. As illustrated, the gaming machine 722 generally comprises a housing or cabinet 726 for supporting and/or enclosing various components required for operation of the gaming machine. In the embodiment illustrated, the housing 726 includes a door located at a front thereof, the door capable of being moved between an open position which allows access to the interior, and a closed position in which access to the interior is generally prevented. The configuration of the gaming machine 722 may vary. In the embodiment illustrated, the gaming machine 722 has an “upright” configuration. However, the gaming machine 722 could have other configurations, shapes or dimensions (such as being of a “slant”-type, “bar-top” or other configuration as is well known to those of skill in the art).

The gaming machine 722 preferably includes at least one first display device 728 configured to display game information. The display device 728 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display device 728 may be capable of projecting or displaying a wide variety of information, including images, symbols and other indicia or information associated with game play, game promotion or other events. The gaming machine 722 might include more than one display device, such as a main or first display device 28 and a secondary display device. The two or more display devices might be associated with the housing or the gaming machine 722 might also include a top box or other portion which includes the one or more second display devices. Also, the gaming machine 722 might include side displays (such as mounted to the exterior of the housing 726) and might include multiple displays of differing sizes.

The gaming machine 722 is preferably configured to present one or more games upon a player making a monetary payment or wager. In this regard, as described in more detail below, the gaming machine 722 includes mechanism or means for accepting monetary value.

In one embodiment, as noted above, certain base game outcomes and side bonus outcomes (but preferably not all outcomes) may be designated as winning outcomes (the non-winning outcomes may be referred to as losing outcomes) and awards may be provided for winning outcomes, such as monetary payments (or representations thereof, such as prize of credits) as detailed herein. As detailed below, the gaming machine 722 preferably includes a mechanism or means for returning unused monetary funds and/or dispensing winnings to a player.

The gaming machine 722 preferably includes one or more player input devices 730 (such as input buttons, plunger mechanisms, a touch-screen display, joystick, touch-pad or the like). These one or more devices 730 may be utilized by the player to facilitate game play, such as by providing input or instruction to the gaming machine 722. For example, such input devices 730 may be utilized by a player to place a wager, cause the gaming machine 22 to initiate a game, to “cash out” of the gaming machine, or to provide various other inputs.

In one preferred embodiment, the gaming machine 722 includes at least one microprocessor or controller for controlling the gaming machine, including receiving player input and sending output signals for controlling the various components or peripheral devices of the machine 722 (such as generating game information for display by the display devices). The controller may be arranged to receive information regarding funds provided by a player to the gaming machine 722, receive input such as a purchase/bet signal when a purchase/bet button is depressed, and receive other inputs from a player. The controller may be arranged to generate information regarding a game, such as generating base game information for display by the at least one display device (such as information comprising dealt cards, etc.), for determining winning or losing base game outcomes and for displaying information regarding awards for winning game wagers, as well as for displaying Side Show Bonus information and outcomes, among other things.

The controller may be configured to execute machine readable code or “software” or otherwise process information, such as obtained from a remote server. Software or other instructions may be stored at a memory or data storage device, e.g. in a fixed or non-transitory configuration. The memory may also store other information or data, such as data stored in table or other forms (including, but not limited to look-up tables, pay tables and other information including tracked game play information). The gaming machine 722 may also include one or more random number generators for generating random numbers (such as implemented by a random number generator software module stored in the memory and executable by the processor), such as for use in selecting the playing cards and for presenting the base game in a random fashion (e.g. whereby the game is presented in a manner in which the player cannot control the outcome) or pseudo-random fashion (e.g. such as where the game includes a skill component which can affect the outcome of the game), and for randomly selecting target Side Show Bonus winning outcomes as described herein. One embodiment of a random RNG engine, RNGCryptoServiceProvider Class, by Microsoft, is set forth below in Table 5.

TABLE 5

Language: c# .net
Code snippet:

| // | |
|---|---|
| // Summary: | |
| // | Fills an array of bytes with a cryptographically strong sequence of random |

values.

//

// Parameters:

| | |
|---|---|
| // | data: |

| | |
|---|---|
| // | The array to fill with a cryptographically strong sequence of random |

values.

| // | |
|---|---|
| // Exceptions: | |
| // | T:System.Security.Cryptography.CryptographicException: |
| // | The cryptographic service provider (CSP) cannot be acquired. |
| // | |
| // | T:System.ArgumentNullException: |
| // | data is null. |

static RNGCryptoServiceProvider _crypto = new RNGCryptoServiceProvider( );
var bytes = new byte[l];
_crypto.GetBytes(bytes);

Preferably, the controller is configured to execute machine readable code or instructions (e.g. software) which are configured to implement the game. In this regard, the gaming machine 722 is specially configured to present the game of the invention via specific software and/or hardware which causes the gaming machine to operate uniquely. For example, the controller of the gaming machine 722 may be configured to detect a wager, such as a signal from a player's depressing of an “game bet” button. Upon such an event and/or the player otherwise signaling the gaming machine to present the game, the controller may be configured to cause the at least one display 728 to display unique information, such as a unique graphical interface or unique game display, including images of playing cards (including as part of player and/or dealer hands and/or community cards) or other game information. The controller may accept input from a player of game inputs via the one or more player input devices of the gaming machine 722. As indicated above, the machine readable code may be configured in various manners, such as by having various “modules” of software which are designed to implement specific features of the game play or game presentation.

The gaming machine 722 may be configured to generate and present games in a stand-alone manner or it may be in communication with one or more external devices or systems at one or more times. The gaming machine 722 might communicate with one or more of such external devices or systems via one or more communication ports or other interface devices. These ports or interface devices may be configured to implement various communication protocols (including proprietary protocols) and communicate via wireless, wired or other communication link. For example, the gaming machine 722 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 722 is configured to present one or more wagering games. The gaming machines 722 is preferably configured to accept value, such as in the form of coins, tokens, paper currency or other elements or devices representing value such as monetary funds. Thus, as indicated above, the gaming machine 722 preferably includes a mechanism or means for accepting monetary value. For example, the gaming machine 722 might include a coin acceptor 732 for accepting coins. Of course, associated coin reading/verifying devices and coin storage devices may be associated with the gaming machine 722 if it is configured to accept coins. Likewise, the gaming machine 722 might include a media reader 734. Such a reader may be configured to accept and read/verify paper currency and/or other media such as tickets. Of course, in such event the gaming machine 722 may further be configured with one or more paper currency or ticket storage devices, such as cash boxes, and other paper currency or media handling devices (including transport devices).

The gaming machine 722 might also be configured to read FOBs, magnetic stripe cards or other media having data associated therewith and via which value or funds may be associated with the gaming machine 722. The mechanism for accepting monetary value might also comprise hardware and/or software which allows a player to transfer (such as electronically) funds from an account, such as a casino wagering account, or a bank or other financial institution account. Such a mechanism might include a communication interface which permits the gaming machine to communicate with a mobile phone, PDA, tablet or other electronic device of the player (such as via a physical interface or wired or wireless communications, such as to enable the transfer of funds from the player to the gaming machine or system.

When the player associates funds with the gaming machine or an associated system, a credit balance is generated. The credit balance may comprise a plurality of monetary value credits. The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). Such wager input options may allow the player to wager on the base game and optionally place a side bonus bet in accordance with the present invention. In one embodiment, when the player's wager is received, the player's credit balance is reduced by the number of wagered credits. The player might then provide a separate input to begin the game. In other embodiment, the player might select a “play game” input, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one embodiment, the gaming machine 722 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. These winnings may be associated with the player's credit balance, thus increasing the player's credit balance.

In one embodiment, the player may provide an input to the gaming machine 722 to indicate their desire to cash out, such as by selecting a “cash out” button or touch screen feature or providing other input. In response, a monetary value represented by the player's credit balance or the like is preferably paid, transferred or otherwise provided to the player. For example, upon an award or at cash-out, associated funds may be paid to the player by the gaming machine 722 dispensing coins to a coin tray 740. In another embodiment, funds may be issued by dispensing paper currency or other media. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference. In yet another embodiment, the cash-out might result in the dispensing of a card or other media which stores or represents the cashed-out funds, such as by writing funds information to a magnetic stripe of a card which is inserted into a media writer of the gaming machine or dispensed from the machine. In this regard, the gaming machine 722 may include one or more media printers or writers 48. In other embodiments, the cash-out mechanism may result in the funds value being transferred to an external device or account, such as a player's casino account (such as associated with a casino server), a remote bank or other financial account, or an electronic device such as a player's phone, PDA or tablet.

The gaming machine 722 may also include a player tracking device, such as a card reader 766 and/or an associated keypad 770 or other input device (such as a touch screen display). Such player tracking devices are well known and may permit the game operator to track play of players of the gaming machine. The tracked play may be utilized to offer player bonuses or awards.

The main game controller or processor may communicate with several of the peripheral devices via one or more intermediary controllers. For example, some of the peripheral devices might comprise USB type or enabled devices which are controlled by an intermediary USB controller.

A casino may have numerous such gaming machines 722, such as located on a casino floor or in other locations. Of course, such gaming machines 722 might be used in other environments, such as an airport, a bar or tavern or other locations.

It will be appreciated that the gaming machine illustrated in FIG. 4 is only exemplary of one embodiment of a gaming machine. For example, it is possible to for the gaming machine to have various other configurations, including different shapes and styles and having different components than as just described.

For example, instead of comprising a “casino”-style gaming machine, it is possible for the game of the invention to be presented on a computing device, including at a home or office computer or a player's mobile electronic device such as a PDA, phone or the like. In one embodiment, a player might log in to a casino server and the controller of the casino server may cause game information to be delivered to the player's computer via a communication link and then be displayed on a display of the player's computer. The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's computer or other electronic device. The local controller at the gaming machine or the player's computer or other electronic device may then cause game information to be displayed on one or more associated displays.

The gaming machine 722 may, as noted above, be part of a system which includes other devices. For example, the gaming machine 722 may communicate with one or more casino systems, such as a player tracking server or system, an accounting system or server, a ticketing system, a bonusing system, a tournament system, other gaming machines, and external devices.

Such a gaming machine 722 might be used, for example, to present the above-referenced game to one or more players in a configuration where the dealer is essentially automated (e.g. including where the gaming machine 722 is essentially configured as a table and may include electronical player stations).

The invention has various advantages. A particular advantage of the invention is a side bonus opportunity for a base game where the target winning side bonus outcome may change, including from game to game. This adds tremendous excitement to the base game, including over existing side bets which are static. In particular, one embodiment, winning Side Show Bonus outcomes of the present invention may be randomly selected and change from game to game. Thus, at the start of each game, the player will be presented with a different side bonus opportunity (even though the base game remains the same game).

It will be appreciated that the variability in the side bonus opportunity may make the base game more exciting because the target winning outcome can change from game to game, requiring the player to evaluate the play of each game to the specific target winning outcome. Because the target winning outcome changes from game to game, just because the player does not receive one specific outcome does not mean that they will not win the side bonus, because a variety of different outcomes may be a winning side bonus.

Another advantage of the invention is that different target outcomes have different payouts. Thus, the player is presented with variability in the amounts that they may win from the Side Show Bonus. As one example, in a blackjack game having a side wager of the occurrence of a 3 card flush, the payout for a winning side bonus is constant and relatively low. In accordance with the invention, the odds of achieving different Side Show Bonus outcomes means that different payouts may be provided. Some of these payouts may be very large (even though the chances of obtaining the outcome are low). The player thus has the chance from time to time of receiving a very large winning payout for the Side Show Bonus, while also having the chance to win lower amounts for outcomes which are more likely to occur.

As disclosed above, the Side Show Bonus may be implemented relative to a base game such as a base wagering game, in order to make the game more exciting. It will be appreciated that such a base game might have other side wager opportunities. For example, the Side Show Bonus of the invention might be implemented relative to a base blackjack game that already has an optional 3 card bonus bet (such as that the player's initial two cards and the dealer's up card comprise a flush). The player might then place either or both the existing side bets and the Side Show Bonus of the present invention.

In one embodiment, the variable Side Show Bonus is implemented electronically, such as by an RNG and associated display. However, it could be implemented in other manners. For example, a deck of Side Show Bonus winning outcome cards may be printed, where each card defines an outcome (and where some outcomes may repeat). The dealer might shuffle the deck and at the start of each base game, deal or display a selected one of the Side Show Bonus cards which thus defines the target outcome for that base game.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method of presenting a game to a player at a gaming table, comprising the steps of:
receiving a game wager and optionally a side bonus bet from said player;
randomly selecting, via a controller of a computing device, a target side bonus winning outcome from a set of a plurality of side bonus winning outcomes stored in a database associated with said controller;
displaying said target side bonus winning outcome via a display associated with said gaming table;
presenting a base wagering game to said player;
determining an outcome of said base wagering game as to said player;
awarding winnings to said player when said outcome of said base wagering game is winning;
when said player placed said optional side bonus bet, determining whether said player received said target side bonus winning outcome as a part of said play of said base wagering game, wherein when said player received said target side bonus winning outcome, awarding said player winnings.

2. The method in accordance with claim 1 wherein said base wagering game is selected from the set consisting of: a poker game, a Pai Gow game, a baccarat game and a blackjack game.

3. The method in accordance with claim 2 wherein said step of presenting said base wagering game to said player comprises dealing a plurality of cards from one or more physical decks of playing cards.

4. The method in accordance with claim 1 wherein at least one of said game wager and side bonus bet are received by an wager input device at said table.

5. The method in accordance with claim 4 wherein said wager input device comprises a wagering chip detector.

6. The method in accordance with claim 1 wherein said plurality of side bonus winning outcomes comprise one or more outcomes which do not comprise a winning outcome of said base wagering game.

7. The method in accordance with claim 1 wherein said winnings for a winning target side bonus winning outcome are defined by a pay table of said target side bonus winning outcomes having associated awards.

8. The method in accordance with claim 1 wherein said winnings for a winning target side bonus winning outcome comprises at least a portion of a progressive jackpot.

9. The method in accordance with claim 1 wherein said step of randomly selecting comprises generating a random number and locating a target side bonus winning outcome corresponding to said generated random number from a table of said set of a plurality of side bonus winning outcomes.

10. The method in accordance with claim 9 wherein said table is a weighted table of said set of side bonus winning outcomes.

11. A game table configured to present a base wagering game and a side bonus, comprising:
a table having a game play surface configured to receive one or more game play pieces for playing said base wagering game, and defining a base wagering game betting location and a side bonus betting location;
a wager detector configured to detect at least one of a base wagering game bet and a side bonus bet;
at least one video display;
a memory storing a table of a plurality of side bonus winning outcomes; and
a controller configured to select a target side bonus winning outcome comprising implementing a random number generator to generate a random number and locating a selected side bonus winning outcome from said table using said random number, and to cause said at least one video display to display said target side bonus winning outcome corresponding to said base wagering game.

12. The game table in accordance with claim 11 wherein said game play pieces comprise a plurality of decks of physical playing cards.

13. The game table in accordance with claim 11 wherein a wager detector is associated with both said base wagering game betting location and said side bonus bet location.

14. The game table in accordance with claim 11 further comprising a dealer input device, wherein said controller is configured to select said target side bonus in response to input to said dealer input device.

15. A gaming machine comprising:
a housing;
a controller;
a memory;
at least one electronic display;
at least one player input device;
at least one device configured to accept a physical element having associated funds for establishing a funds balance;
machine-readable code stored in said memory and executable by said controller to accept input from said player via said at least one player input device of a base game wager and a side bonus wager from said funds balance;
machine-readable code stored in said memory and executable by said controller to cause said controller to randomly select a target side bonus winning outcome from a set of a plurality of side bonus winning outcomes stored in said memory;
machine-readable code stored in said memory and executable by said controller to cause said controller to display said target side bonus winning outcome via said at least one electronic video display;
machine-readable code stored in said memory and executable by said controller to cause said controller to display base wagering game information via said at least one electronic video display;
machine-readable code stored in said memory and executable by said controller to cause said controller to determine an outcome of said base wagering game as to said player and award first winnings when said base outcome is winning; and
machine-readable code stored in said memory and executable by said controller to cause said controller to determine if said player received said target side bonus winning outcome as part of play of said base wagering game and award second winnings when said side bonus outcome is winning.

16. The gaming machine in accordance with claim 15 wherein said base wagering game is selected from the set consisting of: a poker game, a Pai Gow game, a baccarat game and a blackjack game.

17. The gaming machine in accordance with claim 16 wherein said base wagering game information comprise images of one or more playing cards.

18. The gaming machine in accordance with claim 15 wherein said plurality of side bonus winning outcomes are stored in a pay table in said memory.

19. The gaming machine in accordance with claim 18 wherein said second winnings are defined by said pay table.

20. The gaming machine in accordance with claim 15 wherein said machine-readable code stored in said memory and executable by said controller causes said controller to implement a random number generator and said controller utilizes random numbers generated by said random number generator to select said target side bonus winning outcomes from said set of side bonus winning outcomes.
